(19) United States
(12) Patent Application Publication
(10) Pub. No.: US 2022/0242290 A1
(43) Pub. Date: Aug. 4, 2022

(54) VEHICLE SEAT

(71) Applicant: HONDA MOTOR CO., LTD., Tokyo (JP)

(72) Inventors: Toru Inagaki, Tokyo (JP); Takumi Sato, Tokyo (JP)

(21) Appl. No.: 17/579,626

(22) Filed: Jan. 20, 2022

(30) Foreign Application Priority Data
Jan. 29, 2021 (JP) 2021-013272

(51) Int. Cl. B60N 2/90; B60R 16/03

(52) U.S. Cl. CPC B60N 2/90; B60R 16/03

(57) ABSTRACT

To provide a vehicle seat capable of widening a space for a passenger to board. A vehicle seat (1) is provided with a seat back (2) having a support surface which supports a back surface of a passenger; a socket (7) which is provided on the back surface of the seat back (2) opposite to the support surface and to which an external device is connected; and a booster unit (9) which extends from the socket (7) toward an inside of the seat back (2) and is housed inside the seat back (2). The booster unit (9) is disposed diagonally downward from the back surface toward the support surface.

### CROSS-REFERENCE TO RELATED APPLICATION

Priority is claimed on Japanese Patent Application No. 2021-013272, filed Jan. 29, 2021, the content of which is incorporated herein by reference.

### BACKGROUND OF THE INVENTION

### Field of the Invention

The present invention relates to a vehicle seat.

### Description of Related Art

In the related art, in a vehicle seat used for a vehicle such as an automobile, a configuration in which a socket such as a USB socket is provided on a back surface of a seat back for being used by a rear occupant of the vehicle seat is known. In such a vehicle seat, various techniques for improving convenience and comfort of the occupant are proposed.

For example, Patent Document 1 (Japanese Unexamined Patent Application, First Publication No. 2018-90144) discloses a configuration of a vehicle seat which has a back pad housed inside a seat back, a bulging portion that bulges from the seat back to a rear seat side, and an elongated socket that is provided in the bulging portion and extends in a front-rear direction of the seat. The socket is disposed in a space formed between the bulging portion and the back pad not to come into contact with the back pad. According to the technique described in Patent Document 1, because the socket is disposed not to come into contact with the back pad, even when the socket is attached to the back surface of the seat back corresponding to the seating surface with which the body of the seating occupant of the seat back comes into contact, it is possible to prevent the seating occupant from feeling uncomfortable via the back pad.

In the technique described in Patent Document 1, since a booster unit connected to the socket is also disposed inside the seat back, a space under the feet of the occupants sitting in the rear seat can be widened as compared with a case where the booster unit is disposed, for example, at the foot of the vehicle seat. However, in the technique described in Patent Document 1, it is necessary to bulge the seat rearward and create a space inside the seat to prevent the occupant sitting on the seat from feeling uncomfortable. Therefore, the space of the rear seat may be narrowed by the bulging portion.

An object of the present invention is to provide a vehicle seat that can widen the space for occupants to board.

### SUMMARY OF THE INVENTION

The vehicle seat according to the present invention has the following configuration.

(1) A vehicle seat according to an aspect of the present invention includes a seat back having a support surface which supports a back surface of a passenger; a socket which is provided on the back surface of the seat back opposite to the support surface and to which an external device is connected; and a booster unit which extends from the socket toward an inside of the seat back and is housed inside the seat back, and the booster unit is disposed diagonally downward from the back surface toward the support surface.

(2) The vehicle seat according to the aspect (1) may further include a socket housing which is formed to be recessed from the back surface of the seat back to the inside of the seat back and is attached to a skin of the seat back to surround the socket, and an end portion of the socket on the back surface may be located inside the seat back with respect to an opening surface of the socket housing.

(3) In the vehicle seat according to the aspect (2), the socket housing may have an upper inclined surface which is located inside the seat back with respect to the back surface of the seat back and inclines downward from the back surface toward the inside of the seat back, and a lower inclined surface which is located inside the seat back with respect to the back surface of the seat back and below the upper inclined surface, and is inclined upward from the back surface toward the inside of the seat back, and the socket may be provided on the lower inclined surface.

(4) In the vehicle seat according to any one of the aspects (1) to (3), the seat back may have a seat frame inside, and the booster unit may be provided at a position where at least a part of the booster unit overlaps the seat frame in a side view of the seat back, and may be provided on the back surface side with respect to the seat frame.

(5) The vehicle seat according to the aspect (4) may further include a headrest, a head stay which extends from the headrest toward the seat back, and a suspension frame which is suspended between both end portions of the seat frame, and the booster unit may be provided in a region which is surrounded by the seat frame, the head stay, and the suspension frame, in a rear view of the seat back.

According to the aspect of (1), the socket is provided on the back surface of the seat back. By connecting an external device to the socket, the occupant of the rear seat can preferably use an electronic device or the like. The booster unit is housed inside the seat back. Therefore, as compared with a case where the booster unit is disposed at the foot of the seat, the space can be secured below the vehicle seat. Accordingly, it is possible to widen the space for placing the feet of the occupant seated in the rear seat. Further, the booster unit is disposed diagonally downward from the back surface of the seat back toward the support surface. As a result, because the width of the booster unit in the front-rear direction can be reduced while being housed in the seat back, it is not necessary to provide a bulging portion that bulges behind the seat back as in the related art. Therefore, the wide space for the rear seats can be secured.

Therefore, it is possible to provide a vehicle seat that can widen the space for the occupants to board.

In addition, it is possible to suppress deterioration of design due to the provision of the bulging portion and improve the degree of freedom in design. Further, since the width of the booster unit in the front-rear direction can be reduced, it is possible to prevent the booster unit from hitting the occupant seated on the vehicle seat, even when the booster unit is housed in the seat back. Therefore, it is possible to prevent the occupant from feeling uncomfortable.

According to the aspect of (2), the socket housing is recessed from the back surface of the seat back to the inside of the seat back and is disposed to surround the socket. Therefore, the socket can be protected by the socket housing. Since the socket housing is attached to the skin of the seat back, for example, even if the seat back collides with the rear seat or the like when reclining, the impact can be released to the entire seat via the socket housing. As a result, the socket housing and the socket can be protected from impact. The end portion of the socket on the back surface side is located further inside the seat back than the opening surface of the socket housing. Therefore, for example, when the seat back is tilted backward, it is possible to prevent the socket from coming into direct contact with the rear seat or the like. Therefore, in particular, the socket can be reliably protected.

According to the aspect of (3), the socket housing has an upper inclined surface and a lower inclined surface, and the socket is provided on the lower inclined surface. As a result, when an external device such as a USB is connected to the socket, the external device is disposed to protrude in a direction substantially perpendicular to the lower inclined surface, that is, diagonally upward and backward along the upper inclined surface. Therefore, an amount of protrusion of the external device to the rear can be reduced as compared with the configuration in which the socket is provided on the surface parallel to the back surface and the external device is disposed to extend rearward. Therefore, it is possible to secure a wide space of the rear seats when an external device is attached. Further, since the external device is located in the space surrounded by the socket housing, the external device can be protected from an external impact or the like.

According to the aspect of (4), the booster unit is provided at a position where at least a part thereof overlaps the seat frame when viewed from the side surface of the seat back, and is provided on the back surface side of the seat frame. In this way, since the booster unit is disposed at a position where it does not protrude into the region on the front side (support surface side) of the seat frame, it is possible to suppress the occupant seated on the vehicle seat from coming into contact with the booster unit. Therefore, it is possible to prevent the occupant from feeling uncomfortable when sitting. At least a part of the booster unit is provided at a position where it overlaps the seat frame. In other words, the booster unit and the seat frame are provided to be close to each other in the front-rear direction. As a result, it is possible to reduce the amount of protrusion of the booster unit and the seat back toward the rear seats. Therefore, it is possible to secure a wide space of the rear seats, while suppressing discomfort to the occupant seated on the vehicle seat.

According to the aspect of (5), the vehicle seat includes a headrest, a head stay, and a suspension frame. The booster unit is provided in the region surrounded by the seat frame, the head stay, and the suspension frame when viewed in the rear surface of the seat back. Since the booster unit is disposed in the region surrounded by the plurality of frame members in this way, the seated person is unlikely to feel the protruding feeling of the booster unit, and the impact resistance to the booster unit can be improved. Therefore, it is possible to achieve both the comfort of the occupant and the improvement of the protection of the booster unit.

### BRIEF DESCRIPTION OF THE DRAWINGS

FIG. 1 is a perspective view of a vehicle seat according to an embodiment.

FIG. 2 is a rear view of the seat back according to the embodiment.

FIG. 3 is a side view of the seat back according to the embodiment.

FIG. 4 is an enlarged view of a part IV of FIG. 1.

FIG. 5 is a side view of the seat back except a seat frame according to the embodiment.

### DETAILED DESCRIPTION OF THE INVENTION

Hereinafter, embodiments of the present invention will be described with reference to the drawings. In the following description, a front-rear direction, a left-right direction, and a vertical direction coincide with a front-rear direction, a left-right direction, and a vertical direction of a vehicle (not shown) to which a vehicle seat 1 is attached. The left-right direction may be referred to as a vehicle width direction. In the drawings, an arrow FR indicates a forward direction with respect to a vehicle body, an arrow UP indicates an upward direction with respect to the vehicle body, and an arrow LH indicates a leftward direction with respect to the vehicle body.

### (Vehicle Seat)

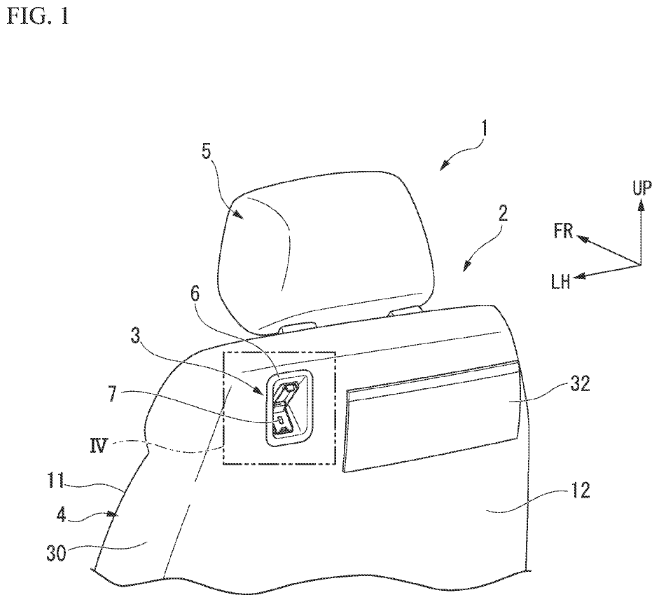

FIG. 1 is a perspective view of the vehicle seat 1 according to the embodiment. The vehicle seat 1 is attached to, for example, an automobile. In the present embodiment, the vehicle seat 1 is applied as a seat for a driver's seat or a passenger seat. The vehicle seat 1 may be applied as a seat other than the driver's seat and the occupant seat.

The vehicle seat 1 includes a seat cushion (not shown), a seat back 2, a headrest 5, and an external device connecting unit 3. A seat cushion (not shown) supports the occupant's buttocks. The seat back 2 is tiltably connected to a rear part of the seat cushion to support a waist and a back of the sitting occupant. The headrest 5 is attached to an upper part of the seat back 2 and supports the neck and head of the sitting occupant.

### (Seat Back)

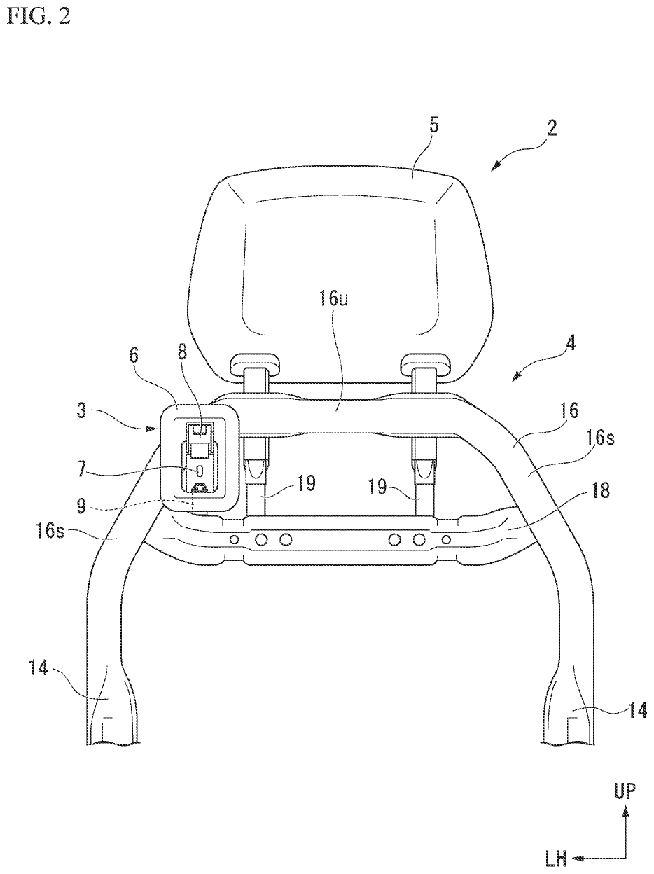

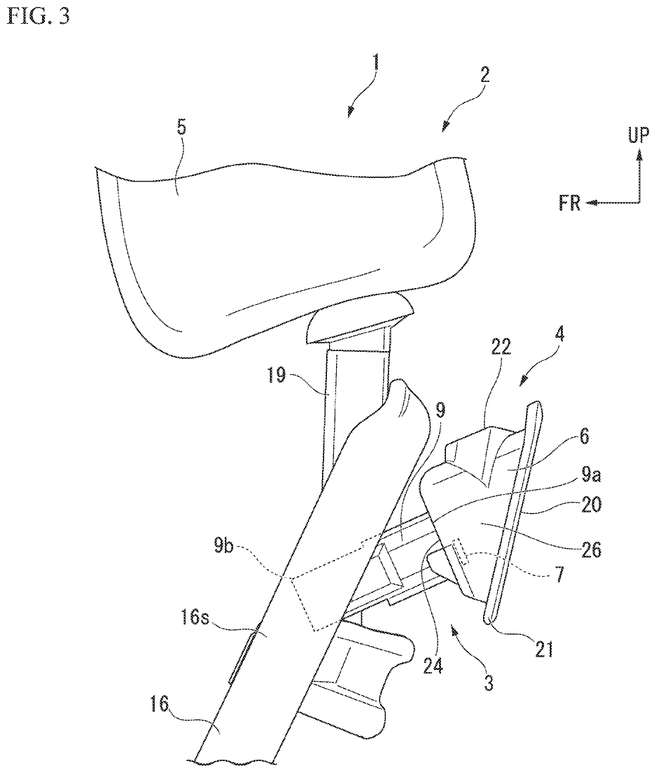

In the following description, in an upright state of the seat back 2 (a state shown in FIG. 1), a front-facing surface of the seat back 2, that is, a surface that supports a back surface of the occupant, is referred to as a “support surface 11.” In the upright state of the seat back 2, a rear-facing surface of the seat back 2, that is, a surface opposite to the support surface 11, is referred to as a “back surface 12.” In the seat back 2, a cushion material is appropriately attached to a plurality of frame members (a seat frame 16 and a suspension frame 18) (see FIGS. 2 and 3), and the outside of the cushion material is covered with a skin 30.

A storage pocket 32 capable of housing articles is attached to a right shoulder portion of the back surface 12 of the seat back 2. The external device connecting unit 3, which will be described in detail, is attached to a left shoulder portion of the back surface 12 of the seat back 2.

FIG. 2 is a rear view of the seat back 2 according to the embodiment when viewed from the rear. FIG. 3 is a side view of the seat back 2 according to the embodiment when viewed from the vehicle width direction. In FIGS. 2 and 3, the cushion material of the seat back 2 and the skin 30 are not shown.

As shown in FIGS. 2 and 3, the seat frame 16 and the suspension frame 18 are provided inside the seat back 2. The seat frame 16 is formed of an iron pipe member. As shown in FIG. 2, the seat frame 16 is bent in a U shape that is convex upward along an outer shape of the upper part of the seat back 2 when viewed from the rear in the front-rear direction.

More specifically, the seat frame 16 has an upper frame portion 16u extending in the vehicle width direction, and a pair of inclined frame portions 16s and 16s extending diagonally downward from both end portions of the upper frame portion 16u and outward in the vehicle width direction. The upper frame portion 16u extends substantially horizontally along the upper end portion of the seat back 2. The pair of inclined frame portions 16s and 16s are each connected to the end portion of the upper frame portion 16u in the vehicle width direction. The left inclined frame portion 16s extends diagonally downward to the left from the left end portion of the upper frame portion 16u along the shoulder portion of the seat back 2. The lower end portion of the left inclined frame portion 16s is connected to the body frame 14 extending in the vertical direction. The inclined frame portion 16s on the right side extends diagonally downward to the right from the right end portion of the upper frame portion 16u along the shoulder portion of the seat back 2. The lower end portion of the right inclined frame portion 16s is connected to the body frame 14 extending in the vertical direction. As shown in FIG. 3, when viewed from the vehicle width direction, the inclined frame portions 16s and 16s are also inclined in the front-rear direction to be located on the front side downward.

As shown in FIG. 2, the suspension frame 18 is formed of an iron plate member. The suspension frame 18 extends in the vehicle width direction. The suspension frame 18 is a press-molded member having the front-rear direction as a thickness direction and formed in an uneven shape in the front-rear direction, in a cross-sectional view orthogonal to the extending direction. The suspension frame 18 is suspended between both end portions of the seat frame 16. Specifically, both end portions of the suspension frame 18 in the vehicle width direction are connected to a pair of inclined frame portions 16s and 16s in the seat frame 16. The seat frame 16 and the suspension frame 18 are joined to each other, for example, by welding. As shown in FIG. 3, the suspension frame 18 is curved to be located rearward from both end portions connected to the seat frame 16 toward a center portion.

As shown in FIG. 2, the headrest 5 is attached to the upper part of the seat back 2. The headrest 5 has a pair of left and right head stays 19 and 19. The head stays 19 extend from the headrest 5 toward the seat back 2. The headrest 5 is attached to the seat back 2 by inserting the head stay 19 into the seat back 2. The seat frame 16 and the suspension frame 18 of the seat back 2 are provided with a headrest bracket (not shown) for supporting the head stay 19. In a state in which the headrest 5 is attached to the seat back 2, the head stay 19 is located in front of the seat frame 16 and the suspension frame 18 (see also FIG. 3).

The pair of head stays 19 and 19 are provided inside the pair of inclined frame portions 16s of the seat frame 16 in the vehicle width direction. Therefore, the left head stay 19, the left inclined frame portion 16s of the seat frame 16 and the suspension frame 18 form a truss-shaped structure surrounded by the head stay 19 and the respective frames 16 and 18 when viewed from the rear. Similarly, the right head stay 19, the right inclined frame portion 16s of the seat frame 16 and the suspension frame 18 form a truss-shaped structure surrounded by the head stay 19 and the respective frames 16 and 18 when viewed from the rear.

### (External Device Connecting Unit)

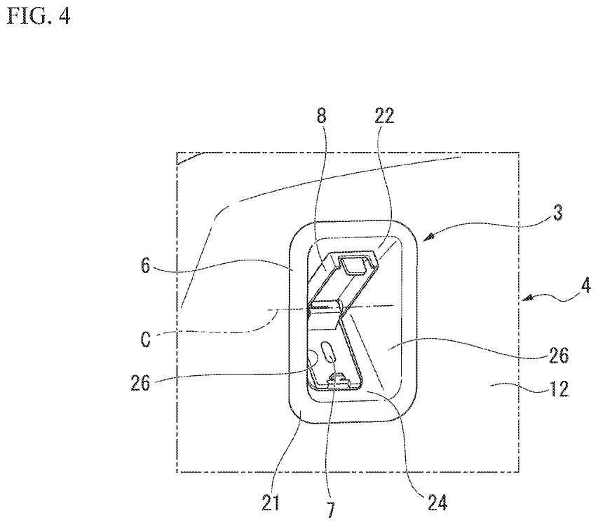

FIG. 4 is an enlarged view of a part IV of FIG. 1.

As shown in FIGS. 1 and 4, the external device connecting unit 3 is provided on the seat back 2. The external device connecting unit 3 can be used by connecting an external device possessed by, for example, a passenger seated on the vehicle seat 1 or a passenger seated on a rear seat located behind the vehicle seat 1. The external device connecting unit 3 of the present embodiment is able to connect, for example, a USB of an external device from the back surface 12 side of the seat back 2. The external device connecting unit 3 has a socket housing 6, a socket 7, a socket cover 8, and a booster unit 9.

The socket housing 6 is provided on the back surface 12 of the seat back 2. The socket housing 6 is formed to be recessed from the back surface 12 of the seat back 2 toward the inside (front) of the seat back 2. The socket housing 6 is formed of a material such as resin. The socket housing 6 is attached to the skin 30 of the seat back 2. The socket housing 6 has a frame portion 21, an upper inclined surface 22, a lower inclined surface 24, and a pair of side surfaces 26 and 26.

The frame portion 21 is attached to the skin 30 on the back surface 12 of the seat back 2. The skin 30 is provided with an opening (not shown), and the frame portion 21 is attached to an edge portion of the opening. The frame portion 21 is formed in a rectangular frame shape when viewed from the rear. An inner region (plane) of the frame portion 21 is an opening surface 20 of the socket housing 6.

The upper inclined surface 22 is located inside the seat back 2 further than the back surface 12 of the seat back 2. The upper inclined surface 22 extends from the upper side of the frame portion 21 toward the inside of the seat back 2. The upper inclined surface 22 is formed in a rectangular plate shape. The upper inclined surface 22 is inclined to be located downward from the frame portion 21 (the back surface 12 of the seat back 2) toward the inside of the seat back 2.

The lower inclined surface 24 is located inside the seat back 2 further than the back surface 12 of the seat back 2. The lower inclined surface 24 is provided below the upper inclined surface 22. The lower inclined surface 24 extends from the lower side of the frame portion 21 toward the inside of the seat back 2. The lower inclined surface 24 is formed in a rectangular plate shape. The lower inclined surface 24 is inclined to be located upward from the frame portion 21 toward the inside of the seat back 2. The front end portion of the upper inclined surface 22 and the front end portion of the lower inclined surface 24 are connected.

The pair of side surfaces 26 and 26 extend from the left side and the right side of the frame portion 21 toward the inside of the seat back 2, respectively. The pair of side surfaces 26 and 26 are provided between the upper inclined surface 22 and the lower inclined surface 24. The pair of side surfaces 26 and 26 are formed in a triangular plate shape. An upper end portion of the left side surface 26 is connected to the left end portion of the upper inclined surface 22 in the vehicle width direction. A lower end portion of the left side surface 26 is connected to the left end portion of the lower inclined surface 24 in the vehicle width direction. The upper end portion of the right side surface 26 is connected to the right end portion of the upper inclined surface 22 in the vehicle width direction. The lower end portion of the right side surface 26 is connected to the right end portion of the lower inclined surface 24 in the vehicle width direction. The pair of side surfaces 26 and 26 are provided substantially parallel to a plane orthogonal to the vehicle width direction.

The socket housing 6 forms a space V that is recessed inside the seat back 2 with respect to the back surface 12 of the seat back 2, by the upper inclined surface 22, the lower inclined surface 24, and the pair of side surfaces 26 and 26. The opening surface 20 located behind the socket housing 6 is substantially flush with the back surface 12 of the seat back 2.

The socket 7 is provided on the lower inclined surface 24. The socket 7 is an insertion port to which the USB of an external device can be connected from the back surface 12 of the seat back 2. The socket 7 is surrounded by the socket housing 6. The end portion of the socket 7 on the back surface 12 side is located inside the seat back 2 further than the opening surface 20 of the socket housing 6. The USB can be inserted into the socket 7 from a direction substantially perpendicular to the lower inclined surface 24. Therefore, the USB connected to the socket 7 protrudes diagonally upward and backward with respect to the back surface 12 of the seat back 2.

The socket cover 8 covers the socket 7 when the socket 7 is not used. The socket cover 8 is formed of a resin-based material. The socket cover 8 is attached to the lower inclined surface 24 of the socket housing 6 to be ratable about a rotation shaft C along the vehicle width direction. The socket cover 8 is displaced into a closed state in which the socket cover 8 is substantially parallel to the lower inclined surface 24 and covers the socket 7, and an open state in which the rear end portion (opening surface 20 side) is rotated upward from the front end portion as a starting point. When using the socket 7, the USB can be inserted by exposing the socket 7 in the open state of the socket cover 8.

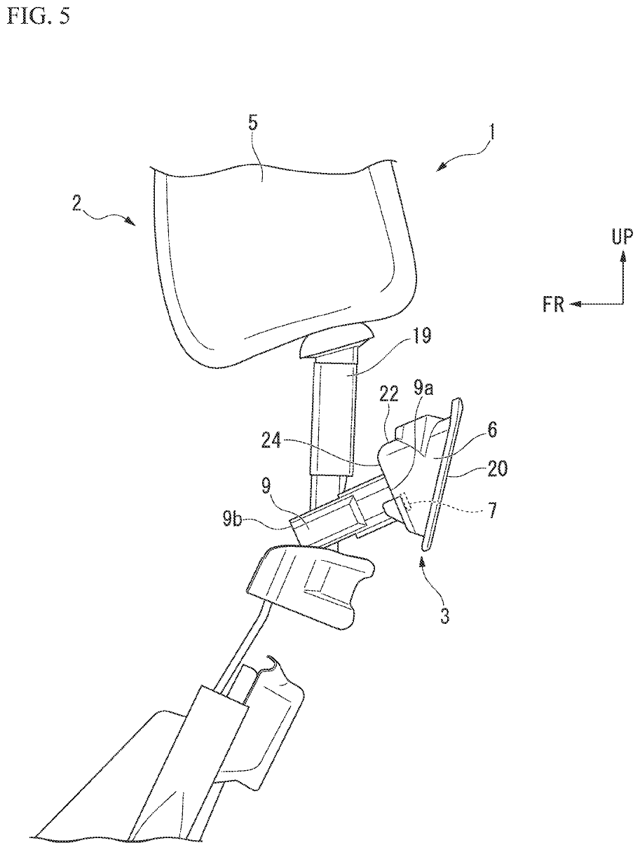

FIG. 5 is a side view of the seat back 2 except the seat frame 16 according to the embodiment. In FIG. 5, the seat frame 16 is not shown for the purpose of explaining the booster unit 9.

The booster unit 9 is connected to the socket 7 and extends from the socket 7 toward the inside of the seat back 2. The booster unit 9 is provided between the socket 7 and a power supply (not shown) of the vehicle body. The booster unit 9 boosts the voltage from the power source of the vehicle body and supplies a current to (external device) of the USB connected to the socket 7.

The booster unit 9 is housed inside the seat back 2. Specifically, the booster unit 9 is provided from the shoulder portion of the seat back 2 on the back surface 12 side to the body portion. The body portion of the seat back 2 is, for example, a portion corresponding to the body portion of a passenger seated on the vehicle seat 1. A rear end portion 9b of the booster unit 9 is attached to the socket housing 6. A front end portion 9a of the booster unit 9 is attached to the lower inclined surface 24 of the socket housing 6. The booster unit 9 extends from the front surface of the lower inclined surface 24 in a direction substantially orthogonal to the lower inclined surface 24. A cushion material is disposed between the socket housing 6 and the seat frame 16, and the booster unit 9 is disposed inside the seat back 2 through the cushion material. The booster unit 9 is disposed to be located downward from the back surface 12 toward the support surface 11 (front).

As shown in FIG. 3, at least a part of the booster unit 9 is provided at a position wherein it overlaps the seat frame 16 in the side view of the seat back 2 and at a position on the back surface 12 side of the seat back 2 further than the seat frame 16. In the present embodiment, the front end portion 9a of the booster unit 9 is located rearward (back surface 12 side) of the front end portion of the inclined frame portion 16s of the seat frame 16 in a side view. In other words, the booster unit 9 is disposed not to protrude forward from the seat frame 16.

As shown in FIG. 2, the booster unit 9 is provided in a region surrounded by the seat frame 16, the head stay 19, and the suspension frame 18 when viewed from the rear. In the present embodiment, the entire booster unit 9 is provided in a region surrounded by the left inclined frame portion 16s of the seat frame 16, the left head stay 19, and the suspension frame 18 when viewed from the rear.

### Operation and Effect

Next, the operation and effect of the above-mentioned vehicle seat 1 will be described.

According to the vehicle seat 1 of the present embodiment, the socket 7 is provided on the back surface 12 of the seat back 2. By connecting an external device to the socket 7, the occupant of the rear seat can preferably use the electronic device or the like. The booster unit 9 is housed inside the seat back 2. Therefore, as compared with a case where the booster unit 9 is disposed at the foot of the seat, the space V can be secured below the vehicle seat 1. Accordingly, it is possible to widen the space V for placing the feet of the occupant seated in the rear seat. Further, the booster unit 9 is disposed diagonally downward from the back surface 12 of the seat back 2 toward the support surface 11. As a result, because the width of the booster unit 9 in the front-rear direction can be reduced while being housed in the seat back 2, it is not necessary to provide a bulging portion that bulges behind the seat back 2 as in the related art. Therefore, the wide space V for the rear seats can be secured.

Therefore, it is possible to provide a vehicle seat 1 that can widen the space V for the occupants to board.

In addition, it is possible to suppress deterioration of design due to the provision of the bulging portion and improve the degree of freedom in design. Further, since the width of the booster unit 9 in the front-rear direction can be reduced, it is possible to prevent the booster unit 9 from hitting the occupant seated on the vehicle seat 1 even when the booster unit 9 is housed in the seat back 2. Therefore, it is possible to prevent the occupant from feeling uncomfortable.

The socket housing 6 is recessed from the back surface 12 of the seat back 2 to the inside of the seat back 2 and is disposed to surround the socket 7. Therefore, the socket 7 can be protected by the socket housing 6. Since the socket housing 6 is attached to the skin 30 of the seat back 2, for example, even if the seat back 2 collides with the rear seat or the like when reclining, the impact can be released to the entire seat via the socket housing 6. As a result, the socket housing 6 and the socket 7 can be protected from impact. The end portion of the socket 7 on the back surface 12 side is located inside the seat back 2 further than the opening surface 20 of the socket housing 6. Therefore, for example, when the seat back 2 is tilted backward, it is possible to prevent the socket 7 from coming into direct contact with the rear seat or the like. Therefore, in particular, the socket 7 can be reliably protected.

The socket housing 6 has an upper inclined surface 22 and a lower inclined surface 24, and the socket 7 is provided on the lower inclined surface 24. As a result, when an external device such as a USB is connected to the socket 7, the external device is disposed to protrude in a direction substantially perpendicular to the lower inclined surface 24, that is, diagonally upward and backward along the upper inclined surface 22. Therefore, an amount of protrusion of the external device to the rear can be reduced as compared with the configuration in which the socket 7 is provided on the surface parallel to the back surface 12 and the external device is disposed to extend rearward. Therefore, it is possible to secure a wide space V of the rear seats when an external device is attached. Further, since the external device is located in the space V surrounded by the socket housing 6, the external device can be protected from an external impact or the like.

The booster unit 9 is provided at a position where at least a part thereof overlaps the seat frame 16 when viewed from the side surface 26 of the seat back 2, and is provided on the back surface 12 side of the seat frame 16. In this way, since the booster unit 9 is disposed at a position where it does not protrude into the region on the front side (support surface 11 side) of the seat frame 16, it is possible to suppress the occupant seated on the vehicle seat 1 from coming into contact with the booster unit 9. Therefore, it is possible to prevent the occupant from feeling uncomfortable when sitting. At least a part of the booster unit 9 is provided at a position where it overlaps the seat frame 16. In other words, the booster unit 9 and the seat frame 16 are provided to be close to each other in the front-rear direction. As a result, it is possible to reduce the amount of protrusion of the booster unit 9 and the seat back 2 toward the rear seats. Therefore, it is possible to secure a wide space V of the rear seats, while suppressing discomfort to the occupant seated on the vehicle seat 1.

The vehicle seat 1 includes a headrest 5, a head stay 19, and a suspension frame 18. The booster unit 9 is provided in the region surrounded by the seat frame 16, the head stay 19, and the suspension frame 18 when viewed in the back surface 12 of the seat back 2. Since the booster unit 9 is disposed in the region surrounded by the plurality of frame members in this way, it is difficult for the seated person to feel the protruding filling of the booster unit 9, and the impact resistance to the booster unit 9 can be improved. Therefore, it is possible to achieve both the comfort of the occupant and the improvement of the protection of the booster unit 9.

The technical scope of the present invention is not limited to the above-described embodiment, and various modifications can be made without departing from the spirit of the present invention.

For example, in the above-described embodiment, a storage pocket 32 may be provided on the left shoulder portion, and the external device connecting unit 3 may be provided on the right shoulder portion. In addition to the storage pocket 32, the seat back 2 may separately have a rotatable simple table, a table on which an external device is installed, and the like.

In addition to the seat frame 16 and the suspension frame 18, other frame members, panel members, and the like may be separately provided inside the seat back 2. In this case, the booster unit 9 may be disposed in a region surrounded by another frame member or the like separately provided when viewed from the rear.

The socket cover 8 may not be provided. According to the present embodiment, the socket 7 is surrounded by the housing and is disposed inside the seat back 2 from the opening surface 20. Therefore, even if the socket cover 8 is not provided, the socket 7 can be protected from an impact due to a collision with the rear seat. However, the configuration of the present embodiment having the socket cover 8 is advantageous in that the socket 7 can be protected more safely.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Vehicle seat
2 Seat back
5 Headrest
6 Socket housing
7 Socket
9 Booster unit
11 Support surface
12 Back surface
16 Seat frame
18 Suspension frame
19 Head stay
20 Opening surface
22 Upper inclined surface
24 Lower inclined surface

What is claimed is:

1. A vehicle seat comprising:
a seat back having a support surface which supports a back surface of a passenger;
a socket which is provided on the back surface of the seat back opposite to the support surface and to which an external device is connected; and
a booster unit which extends from the socket toward an inside of the seat back and is housed inside the seat back,
wherein the booster unit is disposed diagonally downward from the back surface toward the support surface.

2. The vehicle seat according to claim 1, further comprising:
a socket housing which is formed to be recessed from the back surface of the seat back to the inside of the seat back and is attached to a skin of the seat back to surround the socket,
wherein an end portion of the socket on the back surface is located inside the seat back with respect to an opening surface of the socket housing.

3. The vehicle seat according to claim 2, wherein the socket housing has:
an upper inclined surface which is located inside the seat back with respect to the back surface of the seat back and inclines downward from the back surface toward the inside of the seat back, and
a lower inclined surface which is located inside the seat back with respect to the back surface of the seat back and below the upper inclined surface, and is inclined upward from the back surface toward the inside of the seat back, and
the socket is provided on the lower inclined surface.

4. The vehicle seat according to claim 1, wherein the seat back has a seat frame inside, and
the booster unit is provided at a position where at least a part of the booster unit overlaps the seat frame in a side view of the seat back, and is provided on the back surface side with respect to the seat frame.

5. The vehicle seat according to claim 4, further comprising:
a headrest,
a head stay which extends from the headrest toward the seat back, and
a suspension frame which is suspended between both end portions of the seat frame,
wherein the booster unit is provided in a region which is surrounded by the seat frame, the head stay, and the suspension frame, in a rear view of the seat back.
